(19) United States
(12) Patent Application Publication
(10) Pub. No.: US 2009/0028517 A1
(43) Pub. Date: Jan. 29, 2009

(54) REAL-TIME NEAR DUPLICATE VIDEO CLIP DETECTION METHOD

(75) Inventors: Heng Tao Shen, Taringa (AU); Zi Huang, Taringa (AU); Xiaofang Zhou, Brookfield (AU)

Correspondence Address: OHLANDT, GREELEY, RUGGIERO & PERLE, LLP, ONE LANDMARK SQUARE, 10TH FLOOR, STAMFORD, CT, 06901, US

(73) Assignee: The University of Queensland

(21) Appl. No.: 12/180,037

(22) Filed: Jul. 25, 2008

(30) Foreign Application Priority Data
Jul. 27, 2007 (AU) 2007904067

(51) Int. Cl. H04N 5/93

(52) U.S. Cl. 386/52

(57) ABSTRACT

There is provided a near duplicate video detection system. The system includes (a) a video clip acquisition module arranged to produce a video clip in machine readable data format defining a plurality of frames, (b) an image feature extractor in communication with the video clip acquisition module arranged to perform image feature extraction in respect of the frames and produce corresponding image feature extraction data in electronic format, (c) a feature vector generator in communication with the image feature extractor arranged to process the image feature extraction data to produce feature vector data in an electronic format corresponding to each of the frames, and (d) a summarization module responsive to the feature vector generator and arranged to convert the feature vector data into a summarization of the video clip in machine readable format.

### RELATED APPLICATIONS

Priority is claimed under the Paris Convention from Australian provisional patent application number 2007904067 to the present applicant and having the filing date of Jul. 27, 2007.

### FIELD OF THE INVENTION

The present invention relates to systems and methods for content-based video summarization and searching in large video collections. Embodiments of the invention may be of assistance for near-duplicate video clip detection (NDVC).

### BACKGROUND TO THE INVENTION

Near-duplicate video clip (NDVC) detection is an important problem with a wide range of applications such as TV broad-cast monitoring, video copyright enforcement and content-based video clustering and annotation, etc. For a large database with tens of thousands of video clips, each with thousands of frames, NDVC searching in real time may be problematic.

An important research issue in multimedia databases is fast and robust content-based video retrieval (CBVR) in large video collections. A special problem of CBVR is near-duplicate video clip (NDVC) detection, which searches for the near-duplicate video clips of a query clip. Video clips are defined as short clips in video format. Unlike traditional long videos such as TV programs and full movies, video clips are mostly less than 10 minutes in duration and overwhelmingly supplied by amateurs. The widespread popularity of video clips, with the aid of the World Wide Web, has produced a culture of video clip exchanging and viewing. NDVCs are video clips that are similar or nearly duplicate of each other, but appear differently due to various changes introduced during capturing time, setting, lighting condition, background, foreground, etc), transformations (frame format, frame rate, resize, shift, crop, gamma, contrast, brightness, situation, blur, age, sharpen, etc), and editing operations (frame insertion, deletion, swap and content modification). NDVC detection has a wide range of applications such as copyright enforcement, online video usage monitoring, TV broadcasting monitoring, video clustering and annotation, video database purge and cross-modal divergence detection.

One application of NDVC detection arises in TV broadcast monitoring. When a company contracts TV stations for certain commercials, it often asks a market survey company to monitor whether its commercials are actually broadcasted as contracted. These market survey companies are often approached by other companies who are interested in understanding how their competitors conduct advertisements.

While the same commercial is given to all TV stations for broadcasting, it can be broadcasted with some variations, such as TV station-specific parameters (e.g., frame rate, aspect ratio, gamma and resolution), TV reception and recording errors (on signal quality and color degradation), and inserts of different products or contact information (e.g., a supermarket wants to insert different products on sale in the same TV commercial template). Thus, the ‘same’ TV commercial broadcasted by different TV stations at different time are NDVCs. Due to the high complexity of video features (e.g., a sequence of high-dimensional frames), real-time NDVC detection from large video databases is very challenging.

It is an object of the invention to provide an improved method for near duplicate video clip detection.

### SUMMARY OF THE INVENTION

According to a first aspect of the invention there is provided a near duplicate video detection system comprising:

a video clip acquisition module arranged to produce a video clip in machine readable data format defining a plurality of frames;

an image feature extractor in communication with the video clip acquisition module arranged to perform image feature extraction in respect of said frames and produce corresponding image feature extraction data in electronic format;

a feature vector generator in communication with the image feature extractor arranged to process the image feature extraction data to produce feature vector data in an electronic format corresponding to each of said frames;

a summarization module responsive to the feature vector generator and arranged to convert the feature vector data into a summarization of the video clip in machine readable format.

Preferably the summarization module is arranged to process the feature vector data to calculate a bounded coordinate system summarization of the video clip.

In one embodiment the search module is arranged to search over a plurality of test summarizations stored in machine readable format to identify one or more test summarizations distanced less than a predetermined threshold distance from the summarization of the video clip.

The system may include a display assembly responsive to the search module and arranged to indicate the identities of the one or more of test summarizations selected by the search module.

According to another aspect of the invention a method is provided for automatically producing video clip summarization data in machine readable format from a video clip, including the steps of:

a) applying feature extraction to the video clip to thereby form a plurality of feature vectors corresponding to frames of the video clip and having a distribution in a space of predetermined dimensionality;
b) processing the plurality of frame feature vectors to form a series of values statistically characterising the distribution; and
c) storing the series of values in a machine readable format as the summarization of the video clip.

The feature vectors are preferably of a predetermined dimension d and the predetermined dimensionality of the space is also d.

In a preferred embodiment step b) results in a series of d+1 values statistically characterizing the distribution.

The step of processing the plurality of frame feature vectors will typically involve performing principal component analysis on the distribution.

In an exemplary embodiment the step of processing the plurality of frame feature vectors includes performing the principal component analysis as a bounded principal component analysis.

The step of processing the plurality of frame feature vectors may include forming the series of values statistically characterising the distribution based on the bounded principal component analysis whereby said series comprises a bounded coordinate system.

Preferably the feature vectors are of a predetermined dimension d and the bounded coordinate system consists of d+1 values each being d-dimensional.

According to another aspect of the invention there is provided a method of operating a computational device to retrieve one or more video clip summarizations from a plurality of video clip summarizations having been produced by a method according to any one of the preceding claims; said method of retrieving the video clip summarizations further including the steps of:

d) processing query video clips according to claim 5 to thereby produce query summarizations;
e) determining a similarity measure between the query summarizations and ones of the plurality of video clip summarizations; and
f) retrieving the one or more video clip summarizations upon the corresponding similarity measure satisfying a predetermined requirement.

The query video clip summarization preferably comprises a bounded coordinate system BCS(X_{q})=(O^{X}^{_{q}}, \ddot{Φ}₁^{X}^{_{q}}, . . . , \ddot{Φ}_{d}^{X}^{_{q}});
the plurality of video clip summarizations comprise n bounded coordinate systems BCS(Xⱼ)=(O^{X}^{ⱼ}, \ddot{Φ}₁^{X}^{ⱼ}, . . . , \ddot{Φ}_{d}^{X}^{ⱼ}) j=1, . . . , n; and
the predetermined requirement is that the distance

$$D ( BCS ( {X}_{q} ) , BCS ( {X}_{j} ) ) = ‖ {O}^{{X}_{q}} - {O}^{{X}_{j}} ‖ + {\sum }_{i = 1}^{d} ‖ {\ddot{Φ}}_{i}^{{X}_{q}} - {\ddot{Φ}}_{i}^{{X}_{j}} ‖$$

be less than a predetermined value.

The query video clip summarization may comprise a bounded coordinate system BCS(X_{q})=(O^{X}^{_{q}}, \ddot{Φ}₁^{X}^{_{q}}, . . . , \ddot{Φ}_{d}^{X}^{_{q}})
the plurality of video clip summarizations comprise n bounded coordinate systems BCS(Xⱼ)=(O^{X}^{ⱼ}, \ddot{Φ}₁^{X}^{ⱼ}, . . . , \ddot{Φ}_{d}^{X}^{ⱼ}) j=1, . . . , n; and
the predetermined requirement is that the closest video clip summarisation BCS(Xⱼ) be retrieved where

$${min}_{j} D ( BCS ( {X}_{q} ) , BCS ( {X}_{j} ) ) = ‖ {O}^{{X}_{q}} - {O}^{{X}_{j}} ‖ + {\sum }_{i = 1}^{d} ‖ {\ddot{Φ}}_{i}^{{X}_{q}} - {\ddot{Φ}}_{i}^{{Y}_{j}} ‖ .$$

According to another aspect of the invention a video clip processing system is provided, including:
a video clip access assembly to present video clip files in electronic format;
a memory device containing machine readable instructions to convert the video clip files into electronic data containing corresponding video clip summarizations according to the method of claim 5;
   a processor responsive to the video clip access assembly and in communication with the memory device to generate said electronic data containing corresponding video clip summarizations; and
a communications port to make said electronic data accessible to an external computational device.

The video clip processing system may further include a comparator that is responsive to said electronic data and arranged to determine if a summarization of a query video clip is within a predetermined similarity measure to one or more summarizations of test video clips.

The similarity measure may be a least distance for example.

According to another aspect of the present invention there is provided a program storage device, readable by machine, tangibly embodying a program of instructions executable by the machine to cause the machine to perform a method of automatically detecting video clips similar to a query video clip, the method comprising the steps of

a) applying feature extraction to the video clip to thereby form a plurality of feature vectors corresponding to frames of the video clip and having a distribution in a space of predetermined dimensionality;
b) processing the plurality of frame feature vectors to form a series of values statistically characterising the distribution; and
c) storing the series of values in a machine readable format as the summarization of the video clip;
d) determining a similarity measure between the query summarizations and ones of the plurality of video clip summarizations; and
e) retrieving the one or more video clip summarizations upon the corresponding similarity measure satisfying a predetermined requirement.

Preferably, the query video clip summarization comprises a bounded coordinate system;
the plurality of video clip summarizations comprise n bounded coordinate systems and;
the predetermined requirement is that the distance between the query video clip summarization and a one of the video clip summarizations be less than a predetermined value.

According to a further aspect of the invention there is provided, a system for preventing the storage of illegitimate video clips, comprising:
a collection of legitimate video clip summarizations accessible by said webserver and containing summarizations of copyright protected video clips;
a video library webserver including
   a communications port to communicate across a computer network;
   a video clip summarization assembly responsive to the communications port and arranged to convert uploaded electronic video clip files into corresponding test summarizations; and
a comparison module arranged to compare the test summarizations with the legitimate video clip summarizations and prevent storage of potential copyright infringing video clips based on said comparison.

Further preferred features of the present invention will be described in the following detailed description of an exemplary embodiment wherein reference will be made to a number of figures as follows.

### BRIEF DESCRIPTION OF THE DRAWINGS

In order that this invention may be more readily understood and put into practical effect, reference will now be made to the accompanying drawings which illustrate a typical preferred embodiment of the invention and wherein:

FIG. 1 is a diagram depicting two bounded principal components in two dimensions.

FIG. 2a graphically depicts the translation of a first bounded coordinate system (BCS) from its origin to the origin of another BCS.

FIG. 2b graphically depicts the difference of rotation and scaling of two BCSs.

FIG. 3 is a block diagram of a computer system for implementing a preferred embodiment of the present invention.

FIG. 4 is a flowchart of a method for summarizing video clips according to a preferred embodiment of the present invention.

FIG. 5 is a flowchart of a method for identifying near duplicate video clips according to a preferred embodiment of the present invention.

FIG. 6 is a flowchart of a method, according to an embodiment of the invention, for identifying video clips that potentially in breach of copyright of a proprietary video clip.

FIG. 7 is a block diagram of a system, according to an embodiment of the invention, for detecting potentially copyright infringing video clips before they are added to a video clip library.

FIG. 8 is a flowchart of a method, according to an embodiment of the invention, for detecting video clips which may be in infringe copyright.

FIG. 9 is a block diagram of a dedicated hardware near duplicate video detector according to an embodiment of the present invention.

### DETAILED DESCRIPTION OF EXEMPLARY EMBODIMENTS

### Mathematical Background

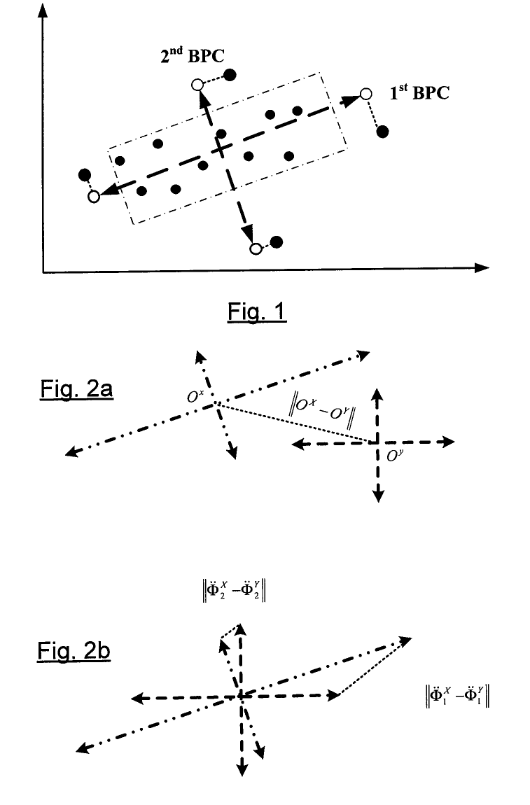

In FIG. 1 the black dots illustrate the frame vector distribution of a sample video clip in 2-dimensional space. Principal Component Analysis can be used to project the data points to a new coordinate system such that the greatest variance comes to lie on the first Principal Component (1stPC), the second greatest variance on the second Principal Component (2ndPC), and so on. Traditionally, a Principal Component (PC) only indicates a direction of the coordinate axis. Here, we explicitly use a bounded scheme called Bounded Principle Component (BPC). For a PC Φᵢ identifying a direction, its corresponding BPC \ddot{Φ}ᵢ identifies a line segment bounded by two furthermost projections on Φᵢ (shown by two circles in FIG. 1) with the length ∥\ddot{Φ}ᵢ∥. BPCs indicate the ranges of feature vector distribution along certain orientations of a video clip.

Real video clips often have some noise points. Since the length of a BPC is determined by two furthermost projections, it is sensitive to noises. FIG. 1 shows such a scenario, where ∥\ddot{Φ}₂∥ is quite large merely due to only a single point at the bottom. To eliminate this negative effect and capture data distribution more robustly, the length of a BPC is redefined with standard deviation, which measures the statistical dispersion of data projections. A BPC \ddot{Φ}ᵢ identifies a line segment bounded by σᵢ, where σᵢ is the standard deviation indicating the average distance of all data points from a projections Φᵢ to the origin of the coordinate system. Its length ∥\ddot{Φ}ᵢ∥=2σᵢ. In FIG. 1, the dashed rectangle shows two corresponding BPCs by σ₁ and σ₂.

Given a video X={x₁, x₂, . . . , xₙ}, where xᵢ is a d-dimensional feature vector (normally n>>d), its Bounded Coordinate System BCS(X)=(O, \ddot{Φ}₁, . . . , \ddot{Φ}_{d}) is determined by the mean (origin) for all xᵢ denoted as O and d BPCs (orientations and ranges). Independent of the frame number n, BCS only records a mean and d BPCs to represent a clip. A BCS actually consists of up to (d+1) d-dimensional points, and is a global summarization that captures the dominating content and its changing trends of a video clip.

The inventors have found that rather than use (d+1) d-dimensional points a BCS may be made up of only the top few most significant BPCs determined by their lengths, without affecting the retrieval quality greatly. From experiments the inventors have determined that a BCS formed from only the first three to five top BPCs (much smaller than d) is usually sufficient for video clip summarization and retrieval, for example.

Given videos X and Y and their summarizations BCS(X)=(O^{X}, \ddot{Φ}₁^{X}, . . . , \ddot{Φ}_{d}^{X}) and BCS(Y)=(O^{Y}, \ddot{Φ}₁^{Y}, . . . , \ddot{Φ}_{d}^{Y}) where d is the numbers of BPCs (or space dimensionality), their video similarity is estimated by the similarity between their BCSs. In each BCS, origin measures the average position of all points, and BPCs indicate the directions of large variances together with the standard deviations of data projections. Two BCSs can be matched by performing translation, rotation and scaling operations. A translation allows one to move its origin to another position (∥O^{X}-O^{Y}∥ as shown graphically in FIG. 2(a)).

A rotation defines an angle which specifies the amount to rotate an axis to match its counterpart in another BCS. A scaling operation can stretch or shrink an axis to be of equal length to another. In vector space, the difference of two vectors is given by the length of their subtraction, which nicely takes both rotation and scaling operations into consideration to match two corresponding BPCs (∥\ddot{Φ}ᵢ^{X}-\ddot{Φ}ᵢ^{Y}∥, shown graphically in FIG. 2(b)). Therefore, the distance between two BCSs is defined as:

$$D ( BCS ( X ) , BCS ( Y ) ) = ‖ {O}^{X} - {O}^{Y} ‖ + {\sum }_{i = 1}^{d} ‖ {\ddot{Φ}}_{i}^{X} - {\ddot{Φ}}_{i}^{Y} ‖$$

The smaller this distance the greater the likelihood that video clip X and video clip Y are duplicates or near duplicates.

### Implementation

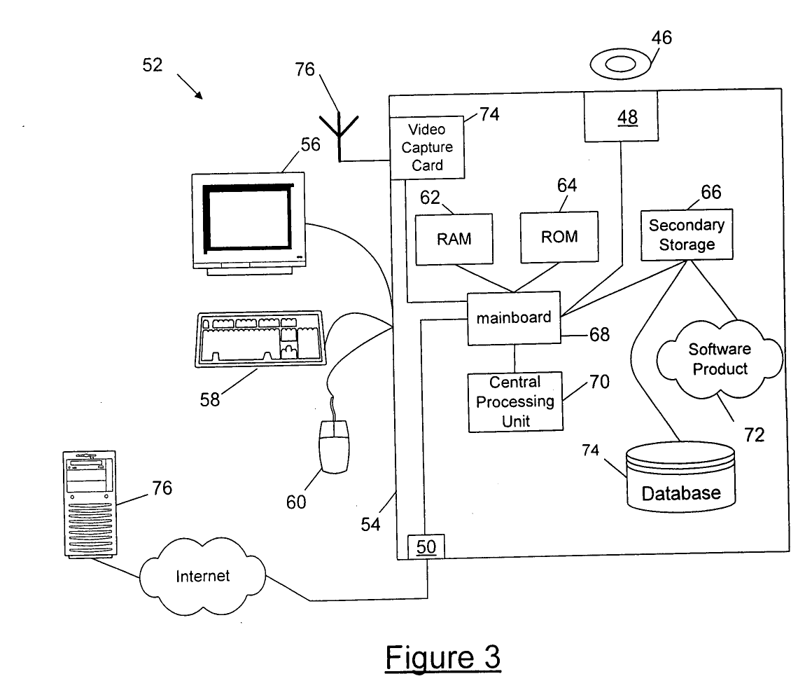

Referring now to FIG. 3, there is depicted a computational device in the form of a personal computer system 52. The computer system will preferably equal or exceed the performance of a Windows® XP platform with Intel® Core 2 CPU (2.4 GHz) and 2.0 GB RAM. Computer system 52 operates as a real-time near duplicate video clip detection system according to a preferred embodiment of the present invention while executing a NDVCD computer program which will be described shortly. Personal Computer system 52 includes data entry devices in the form of pointing device 60 and keyboard 58 and a data output device in the form of display 56. The data entry and output devices are coupled to a processing box 54 which includes a central processing unit 70.

Central processing unit (CPU) 70 interfaces with storage devices that are readable by machine and which tangibly embody programs of instructions that are executable by the CPU. These storage devices include RAM 62, ROM 64 and secondary storage devices i.e. a magnetic hard disk 66 and optical disk reader 48, via mainboard 68. The personal computer system also includes a network port 50 so that it can exchange data. For example, the personal computer system may receive query video clips over computer networks such as the Internet from remote parties, search for the identity of one or more near duplicate video clips and return the search results over the Internet. Computer system 52 also includes a video capture card 74, which includes a TV tuner in order that the system can monitor and record cable television, or radio frequency broadcast television via antenna 76.

It will be realised that the video capture card 74 and network port 50 constitute examples of video clip access assemblies for presenting video clip files in electronic format to the remainder of the computer system 52. Other video clip access assemblies are possible, for example a digital video camera.

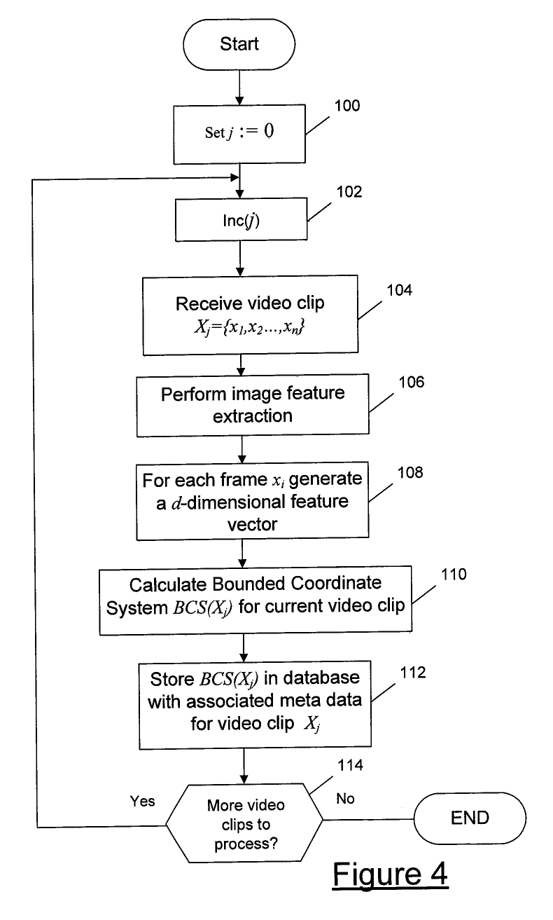

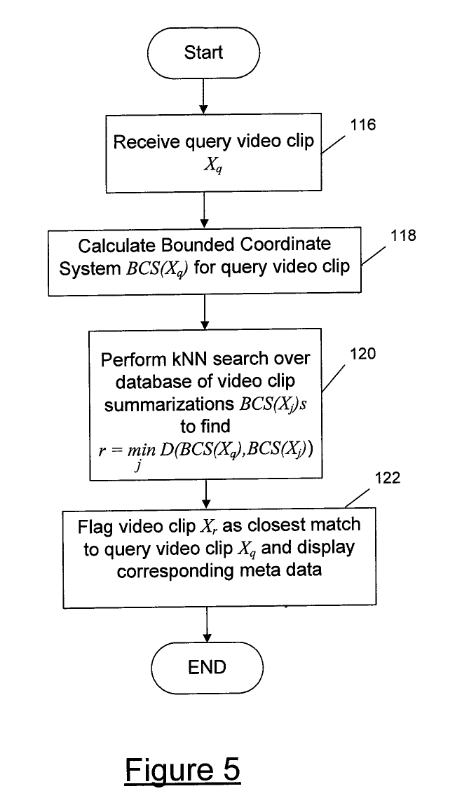

Secondary storage device 66 is a magnetic data storage medium that bears instructions, for execution by central processor 70. These instructions will typically have been installed from an installation disk such as optical disk 46 although they might also be provided in a memory integrated circuit or via a computer network from a remote server installation. The instructions constitute a software product 72 that when executed causes computer system 52 to operate as a NDVCD system and in particular to implement a NDVCD method that will be described shortly with reference to the flowcharts of FIGS. 4 and 5. Operation of the software product produces a database 74 for storing the BCSs and associated meta data of video clips that are processed. Alternatively, the database may be located remotely from the PC and accessed over a computer network such as the Internet. It is preferred that the compact video representations, i.e. “summarisations” being the BCSs, and associated meta data for each video clip, be indexed to reduce search space. A preferable indexing method is to use B⁺-tree indexing.

It will be realised by those skilled in the art that the programming of software product 72 is straightforward in light of the method of the present invention, a preferred embodiment of which will now be described. In the following method various variables are manipulated. It will be realised that during operation of computer system 52 to implement the method corresponding registers of CPU 70 will be incremented and data written to and retrieved from secondary storage 66 and RAM 62 by virtue of electrical signals travelling along conductive busses etched on mainboard 68. Consequently, physical effects and transformations occur within computer system 52 as it executes software 72 to implement the methods that will now be described.

It will be further realised that computer system 52, under control of software product 72, may be operated to transform a video clip from an external source, for example the Internet or television broadcast, into a summarization file that may in turn be exported to another computer system for near duplicate video detection. Alternatively, software product 72 may contain instructions to not only produce the summarizations but also to compare summarizations in order to detect near duplicate video clips.

FIG. 4 is a flowchart of a method according to a preferred embodiment of the present invention for processing video clips to produce corresponding compact summarizations.

At box 100 a video clip counter j is initialized to zero. At box 10 the counter is incremented and at box 104 the j^{th} video clip Xⱼ, which is composed of n frames xᵢ is retrieved, for example from secondary storage 66 or from a given URL over the internet.

At box 106 image feature extraction is performed. During this step the user may be prompted to input a preferred color space, e.g. RGB or HSV color space or dimensionality of the feature vectors, e.g. 8, 16, 32 or 64.

At box 108, for each frame xᵢ a corresponding d-dimensional feature vector is produced on the basis of the preceding image feature extraction step. In the preferred embodiment a color histogram approach to frame feature extraction is used. A classical reference on this topic is Color Indexing by Michael J. Swain and Dana H. Ballard, published in the International Journal of Computer Vision, Vol. 7, Issue 1, November 1991 by Kluwer Academic Publishers, the content of which is hereby incorporated in its entirety by reference. While the color histogram approach is presently preferred, those skilled in the art of computer graphics will recognize that virtually any arbitrary frame feature might be used for frame feature extraction.

At box 110 the banded coordinate system BCS(Xⱼ)=(O^{Xj}, \ddot{Φ}₁^{Xj}, . . . , \ddot{Φ}_{d}^{Xj}) is calculated.

At box 112 the value of BCS(Xⱼ) is stored in database 74 along with associated meta data for the video clip Xⱼ. The meta-data will for example be the title of the video clip, filename, video length, video format and file size, as required.

At box 114 program control diverts back to box 102, if there are more video clips to be summarized. Otherwise the process ends.

The result of the process are summarizations i.e. Bounded Coordinate System values BCS(Xⱼ)=(O^{X}^{ⱼ}, \ddot{Φ}₁^{X}^{ⱼ}, . . . , \ddot{Φ}_{d}^{X}^{ⱼ}) for each of video clip. The summarizations are stored in database 72 along with corresponding video clip metadata.

Referring now to FIG. 5, there is depicted a flowchart of a method according to a preferred embodiment of the invention for querying the database to identify a video clip Xᵣ closest to a query video clip X_{q}.

At box 116 computer system 52 receives the query video clip X_{q} either from secondary storage 66, over a computer network such as the Internet, from an optical disk 46 or some other data source. At box 118 the bounded coordinate system BCS(X_{q}) for the query video clip is calculated. The calculation at box 118 is entirely analogous to that of boxes 104 to 110 of FIG. 4.

At box 120 a k nearest neighbour (kNN) similarity search is performed over the BCSs stored in database 74 to find the record closest to BCS(X_{q}) This is done by finding r, being the index j of the BCS(Xⱼ) that is closest to BCS(X_{q})=(O^{X}^{_{q}}, \ddot{Φ}₁^{X}^{_{q}}, . . . , \ddot{Φ}_{d}^{X}^{_{q}}) so that:

$$r = {min}_{j} D ( BCS ( {X}_{q} ) , BCS ( {X}_{j} ) ) = ‖ {O}^{{X}_{q}} - {O}^{{X}_{j}} ‖ + {\sum }_{i = 1}^{d} ‖ {\ddot{Φ}}_{i}^{{X}_{q}} - {\ddot{Φ}}_{i}^{{Y}_{j}} ‖$$

where r is a variable that holds the value of the index j which minimises the above expression.

At box 122 video clip Xᵣ is flagged, by displaying a suitable message on display screen 56, as having the summarisation, i.e. BCS(Xᵣ) in database 72 being closest to the summarisation, i.e. BCS(X_{q}), of the test video clip X_{q}.

The software product may include further instructions in order for the computer system to display the closest video clip Xᵣ on display 56. If desired the software product may include instructions for key frames from video clip Xᵣ to be played alongside corresponding key frames from the query video clip X_{q}. In other variations the software product may include instructions to identify a number of video clips whose corresponding BCS values are within a predetermined radius distance from the BCS(X_{q}) of the query video clip. Key frames of these closest video clips can then be viewed side by side with key frames of the query video clip if desired.

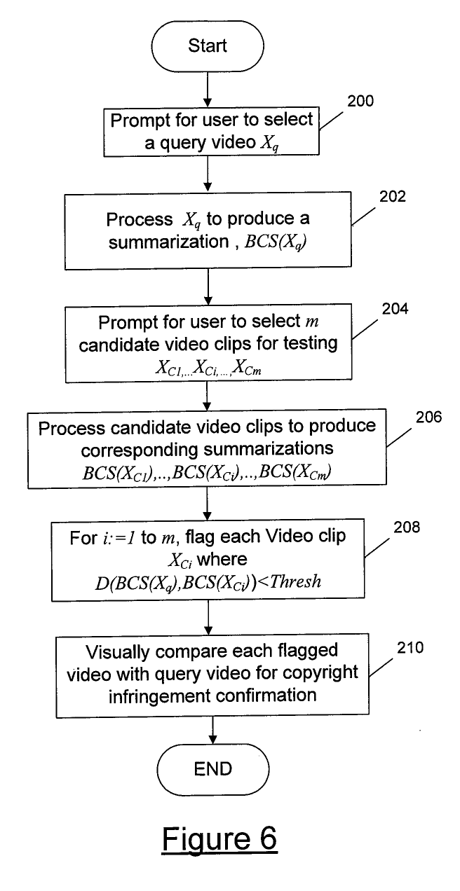

Referring now to FIG. 6, a flowchart is provided of a further embodiment of the present invention for detecting potential copyright infringements of video clips. The method is performed by operating a computational device such as computer system 52 under control of a software product 72, wherein the software product includes instructions for the central processing unit 70 to perform the steps set out in the boxes of FIG. 6.

At box 200 of FIG. 6 an operator of computer system 52 is prompted, via display 56, to select a query video X_{q}, being a video that is known to be vested with copyright. The operator, i.e. the user of system 52, will typically select the video X_{q} from secondary storage 66 or from a remote server 76 via the Internet.

At box 202 central processing unit 70 processes video clip X_{q} to produce a summarisation BCS(X_{q}). Preferably this is done according to the method previously described with reference to FIG. 4. At box 204 the operator is prompted to select candidate video clips X_{ci} for testing. This step may include prompting the operator to input descriptive keywords, or meta-data, about the query video X_{q}. For example, if video X_{q} is from a particular episode of a TV series then the operator may enter the names of the actors in the scene, the title of the episode and of the series, and any other noteworthy descriptive words about the narrative content of the scene. The computer system can then use these keywords to search remote servers via Internet search engines for a number (say m) candidate video clips X_{ci} that are associated with these keywords.

At box 206 central processing unit 70 processes each of the candidate video clips X_{ci} to produce summarizations BCS(X_{ci}), i=1, . . . , m. Subsequently, at box 208, the distance D), between the query video clip and each of the candidate video clips is calculated. Whenever the distance is calculated to be less than a predetermined threshold value, Thresh, the corresponding candidate video clip is flagged as constituting a potential copyright violation of the query video clip.

At box 210 the flagged video clips are presented for human viewing in order to make a final determination as to whether or not a copyright violation has occurred.

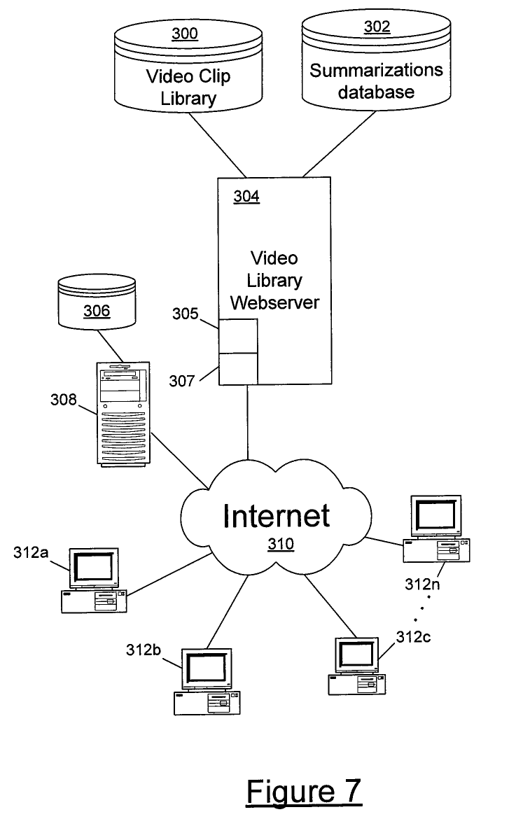

FIG. 7 depicts a video library internet web server 304, in communication with a number of remote browser personal computers 312 by means of communications port 307 via Internet 310. The web server 304 maintains a video clip library 300 of video clips that are uploaded over Internet 310 from remote computers 312. A problem that can arise for video library internet web servers, for example YouTube® (http://www.youtube.com) is that although operators of remote computers 312 are warned not to upload illegitimate clips, e.g. copyright protected material that they do not own, nevertheless they may still do so. In order to address this problem, an embodiment of the present invention provides for video clip copyright owners to maintain a server 308 having a database 306 of summarizations of the copyright video clips. These summarizations are preferably produced according to the method described with reference to FIG. 4. The summarizations of the copyright video clips are periodically uploaded to video library webserver 304 which in turn stores them in database 302. Alternatively the video clips may be uploaded and summarized by summarization module 305 of webserver 304. The summarization module may be a suitably programmed processor or alternatively a dedicated hardware module.

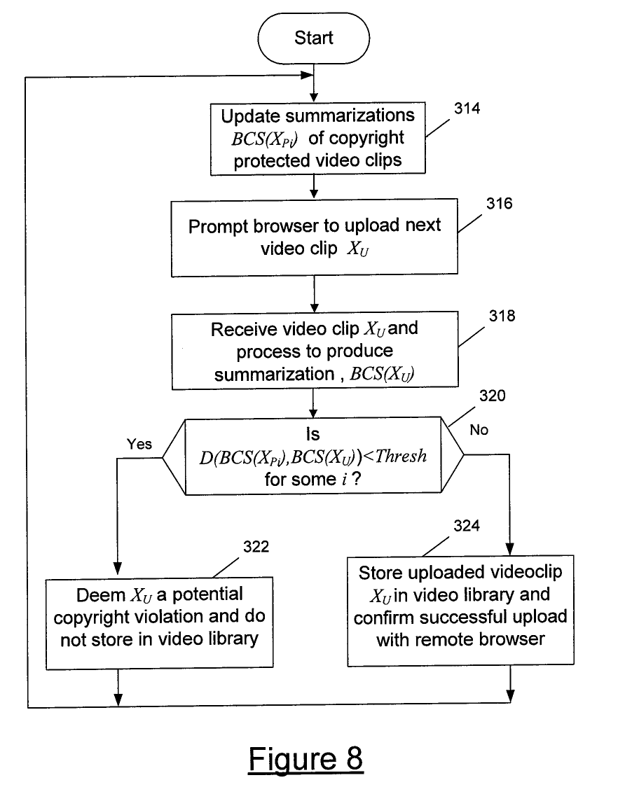

Turning now to FIG. 8, there is depicted a flowchart of a method according to an embodiment of the invention by which video library webserver 304 is able to avoid storing potentially copyright infringing video clips uploaded by remote computers 312.

At box 314 any recent summarizations of copyright protected video clips are uploaded from server 308 and stored in summarizations database 302.

At box 316 a remote browser, e.g. an operator of computer 312a, who is a subscriber to the video library service that provides webserver 304, and wishes to upload a video, is prompted to select a video clip stored on computer 312a for upload.

At box 318 the webserver 304 receives the video clip for uploading via port 307, X_{U}, and processes with summarization module 305 it to produce a corresponding summarization. Preferably the summarization is performed according to the method described previously with reference to FIG. 4.

At box 320 the webserver calculates the distance between the summarization of the uploaded video with each of the summarizations stored in database 302 of copyright protected video clips. If the distance between the summarization of the uploaded video clip and any one of the summarizations of copyright protected video clips is less than a predetermined threshold value Thresh, then (at box 322) the uploaded video clip will be discarded and not stored in video clip library 300. Alternatively (at box 324), if the calculated distance is greater than the threshold value for all of the summarizations of copyright protected video clips, then the uploaded video clip will be deemed to not constitute a potential copyright infringement and will be stored in video clip library 300.

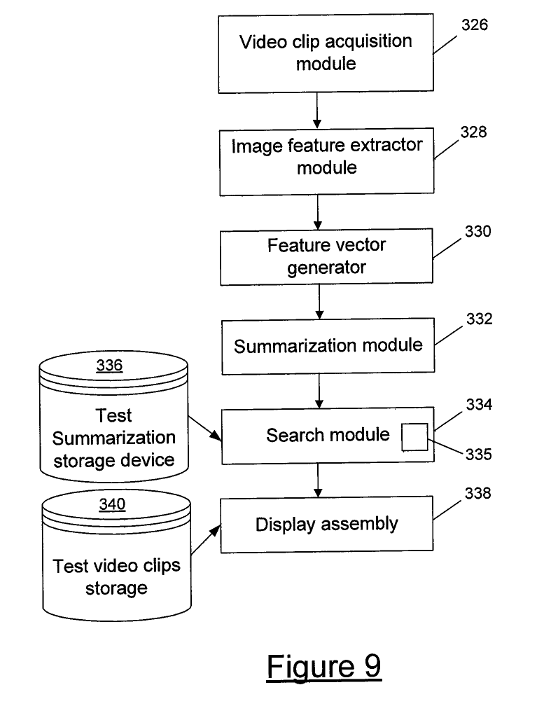

Referring now to FIG. 9, there is depicted a near duplicate video clip detector 325 implemented as a dedicated hardware embodiment of the invention. Detector 325 may be built as a very large scale integrated circuit (VLSIC) or about a suitably configured field programmable gate array (FPGA), for example.

While embodiments of the invention may be implemented on a suitably programmed personal computer, as previously described with reference to FIG. 3, a dedicated hardware implementation may be preferred in some situations since the various computations mentioned in the previously described methods can be optimized for processing speed efficiency.

Detector 325 comprises a video clip acquisition module 326 that is arranged to produce a video clip in machine readable data format, e.g. xvid, divx, avi, MP3 or MP4 data files. The video clip acquisition module 326 may include a broadcast frequency television tuner or a computer network communications port, such as an ICMP protocol Internet port. An image feature extractor module 328 is electrically connected to detector 326 in order that it can receive the video clip file. In the presently described embodiment, image feature extractor 328 is hardwired to perform color histogram based feature extraction. The image feature extractor produces electrical signals corresponding to image feature extraction data to which feature vector generator 330 is responsive.

The feature vector generator is arranged to process the image feature extraction data signal to produce feature vector data in an electronic format corresponding to each of said frames. For example, the feature vector data will typically be presented as electrical signals to summarization module 332 via a communications bus.

Summarization module 332 receives the electronic format feature vector data and processes it to calculate a bounded coordinate system summarization of the video clip file in an electronic format. This summarization is then passed to search module 334 which processes it as a query summarization.

Search module 334 is connected to the output side of summarization module 332 and also communicates with hardware storage device 336 containing test summarizations for each of a number of video clips. In operation the search module searches over the test summarizations to find those summarizations which are closest to the query summarization. In order to do this the search module contains a dedicated hardware comparator 335 to determine if the distance between the bounded coordinate system of the query summarization and the bounded coordinate system of a test summarization is less than a predetermined threshold value, which constitutes a similarity measure. The search module may be configured to locate all test summarizations having a distance from the query summarization that is less than a predetermined threshold value. In other embodiments the search module may simply find the closest test summarization, or search according to some other desired predetermined criteria.

A display assembly 338 is coupled to the search module 334 and arranged to display the identity of the result test summarizations. The display assembly may include a video driver and display for running video clips corresponding to the search result test summarizations. The display assembly can be configured to play the entire video clip or alternatively to play only key frames. In a preferred embodiment the test result video is played back side by side with the video clip that corresponds to the query summarization which are stored in memory device 340. It will be realised that in some circumstances it will be most convenient for storage devices 336 and 340 to be replaced by corresponding portions of a single memory device. Consequently a human operator may readily check just how close to being identical the clips actually are.

The embodiments of the invention described herein are provided for purposes of explaining the principles thereof, and are not to be considered as limiting or restricting the invention since many modifications may be made by the exercise of skill in the art without departing from the scope of the invention as set forth in the following claims.

We claim:

1. A near duplicate video detection system comprising:
a video clip acquisition module arranged to produce a video clip in machine readable data format defining a plurality of frames;
an image feature extractor in communication with the video clip acquisition module arranged to perform image feature extraction in respect of said frames and produce corresponding image feature extraction data in electronic format;
a feature vector generator in communication with the image feature extractor arranged to process the image feature extraction data to produce feature vector data in an electronic format corresponding to each of said frames;
a summarization module responsive to the feature vector generator and arranged to convert the feature vector data into a summarization of the video clip in machine readable format.

2. A system according to claim 1, wherein the summarization module is arranged to process the feature vector data to calculate a bounded coordinate system summarization of the video clip.

3. A system according to claim 2, further including a search module arranged to search over a plurality of test summarizations stored in machine readable format to identify one or more test summarizations distanced less than a predetermined threshold from the summarization of the video clip.

4. A system according to claim 3, including a display assembly responsive to the search module and arranged to indicate the identities of the one or more of test summarizations selected by the search module.

5. A method for automatically producing video clip summarization data in machine readable format from a video clip, including the steps of:
a) applying feature extraction to the video clip to thereby form a plurality of feature vectors corresponding to frames of the video clip and having a distribution in a space of predetermined dimensionality;
b) processing the plurality of frame feature vectors to form a series of values statistically characterising the distribution; and
c) storing the series of values in a machine readable format as the summarization of the video clip.

6. A method according to claim 5, wherein the feature vectors are of a predetermined dimension d and wherein the predetermined dimensionality of the space is also d.

7. A method according to claim 6, wherein step b) results in a series of d+1 values statistically characterizing the distribution.

8. A method according to claim 5, wherein the step of processing the plurality of frame feature vectors includes performing principal component analysis on the distribution.

9. A method according to claim 8, wherein the step of processing the plurality of frame feature vectors includes performing the principal component analysis as a bounded principal component analysis.

10. A method according to claim 9, wherein the step of processing the plurality of frame feature vectors includes forming the series of values statistically characterising the distribution based on the bounded principal component analysis whereby said series comprises a bounded coordinate system.

11. A method according to claim 10, wherein the feature vectors are of a predetermined dimension d and the bounded coordinate system consists of d+1 values each being d-dimensional.

12. A method of operating a computational device to retrieve one or more video clip summarizations from a plurality of video clip summarizations having been produced by a method according to any one of the preceding claims; said method of retrieving the video clip summarizations further including the steps of:
d) processing query video clips according to claim 5 to thereby produce query summarizations;
e) determining a similarity measure between the query summarizations and ones of the plurality of video clip summarizations; and
f) retrieving the one or more video clip summarizations upon the corresponding similarity measure satisfying a predetermined requirement.

13. A method according to claim 12, wherein
the query video clip summarization comprises a bounded coordinate system BCS(X_{q})=(O^{X}^{_{q}}, \ddot{Φ}₁^{X}^{_{q}}, . . . , \ddot{Φ}_{d}^{X}^{_{q}});
the plurality of video clip summarizations comprise n bounded coordinate systems BCS(Xⱼ)=(O^{X}^{ⱼ}, \ddot{Φ}₁^{X}^{ⱼ}, . . . , \ddot{Φ}_{d}^{X}^{ⱼ}) j=1, . . . , n; and
the predetermined requirement is that the distance
$$D ( BCS ( {X}_{q} ) , BCS ( {X}_{j} ) ) = ‖ {O}^{{X}_{q}} - {O}^{{X}_{j}} ‖ + {\sum }_{i = 1}^{d} ‖ {\ddot{Φ}}_{i}^{{X}_{q}} - {\ddot{Φ}}_{i}^{{X}_{j}} ‖$$
be less than a predetermined value.

14. A method according to claim 12, wherein
the query video clip summarization comprises a bounded coordinate system BCS(X_{q})=(O^{X}^{_{q}}, \ddot{Φ}₁^{X}^{_{q}}, . . . , \ddot{Φ}_{d}^{X}^{_{q}});
the plurality of video clip summarizations comprise n bounded coordinate systems BCS(Xⱼ)=(O^{X}^{ⱼ}, \ddot{Φ}₁^{X}^{ⱼ}, . . . , \ddot{Φ}_{d}^{X}^{ⱼ}) j=1, . . . , n; and
the predetermined requirement is that the closest video clip summarisation BCS(Xⱼ) be retrieved where
$${min}_{j} D ( BCS ( {X}_{q} ) , BCS ( {X}_{j} ) ) = ‖ {O}^{{X}_{q}} - {O}^{{X}_{j}} ‖ + {\sum }_{i = 1}^{d} ‖ {\ddot{Φ}}_{i}^{{X}_{q}} - {\ddot{Φ}}_{i}^{{Y}_{j}} ‖ .$$

15. A video clip processing system including:
a video clip access assembly to present video clip files in electronic format;
a memory device containing machine readable instructions to convert the video clip files into electronic data containing corresponding video clip summarizations according to the method of claim 5;
a processor responsive to the video clip access assembly and in communication with the memory device to generate said electronic data containing corresponding video clip summarizations; and
a communications port to make said electronic data accessible to an external computational device.

16. A video clip processing system according to claim 15, further including:
a comparator responsive to said electronic data and arranged to determine if a summarization of a query video clip is within a predetermined similarity measure to one or more summarizations of test video clips.

17. A video clip processing system according to claim 16, wherein the comparator is arranged to determine the similarity measure as a least distance.

18. A program storage device, readable by machine, tangibly embodying a program of instructions executable by the machine to cause the machine to perform a method of automatically detecting video clips similar to a query video clip, the method comprising the steps of
a) applying feature extraction to the video clip to thereby form a plurality of feature vectors corresponding to frames of the video clip and having a distribution in a space of predetermined dimensionality;
b) processing the plurality of frame feature vectors to form a series of values statistically characterising the distribution; and
c) storing the series of values in a machine readable format as the summarization of the video clip;
d) determining a similarity measure between the query summarizations and ones of the plurality of video clip summarizations; and
e) retrieving the one or more video clip summarizations upon the corresponding similarity measure satisfying a predetermined requirement.

19. A program storage device according to claim 18, wherein
the query video clip summarization comprises a bounded coordinate system;
the plurality of video clip summarizations comprise n bounded coordinate systems and;
the predetermined requirement is that the distance between the query video clip summarization and a one of the video clip summarizations be less than a predetermined value.

20. A system for preventing the storage of illegitimate video clips, comprising:
a collection of legitimate video clip summarizations accessible by said webserver and containing summarizations of copyright protected video clips;
a video library webserver including
a communications port to communicate across a computer network;
a video clip summarization assembly responsive to the communications port and arranged to convert uploaded electronic video clip files into corresponding test summarizations; and
a comparison module arranged to compare the test summarizations with the legitimate video clip summarizations and prevent storage of potential copyright infringing video clips based on said comparison.
